(19) United States
(12) Patent Application Publication
(10) Pub. No.: US 2004/0203586 A1
(43) Pub. Date: Oct. 14, 2004

(54) Auction system and process for facilitating online acquisition of telecommunications services

(76) Inventor: James P. Cashiola, Austin, TX (US)

Correspondence Address: Erik B. Cherdak & Associates, LLC, Suite 906, 11300 Rockville Pike, Rockville, MD, 20852, US

(21) Appl. No.: 10/199,497

(22) Filed: Jul. 22, 2002

(51) Int. Cl. H04Q 7/00

(52) U.S. Cl. 455/407; 455/414.1

(57) ABSTRACT

An online auction system for facilitating acquisition of telecommunications services includes an online auction facility operable to facilitate an online auction and to permit a telecommunications service to be auctioned to a high bidder. The online auction system also includes a service provider system that is coupled to the online auction facility via an electronic data network. The service provider system is operable to automatically provide the telecommunications service to the high bidder automatically when the high bidder wins the online auction.

### BACKGROUND OF THE INVENTION

1. Field of the Invention

The present invention relates to systems and methods used to automatically provision telecommunications services. More particularly, the present invention relates to systems and methods used to provide telecommunications services based on requests for the same received via corresponding web based sessions and as a result of auction operations and processes.

2. Description of the Related Art

Despite incredible advances in technology over the past several years, obtaining telecommunications services such as voice services, data services, broadband services, etc. still requires application of business practices which are riddled with inefficiencies, high productivity costs, and, at worst, paper based processes that do not permit consumers to self direct and manage their communications solutions.

Take for example, purchasing and obtaining residential telephone services. Typically, a consumer has to call a central telephone service facility or office, request service, receive a confirmation or order number, and then wait until a scheduled date for a live operator to simply and merely “flip a switch” (update a database entry) to activate service for the consumer. Then, after service is initiated, the consumer must wait for periodic (usually monthly) paper statements that are sent via post such as the U.S. Mail to learn about telephone service usage, call rates, and call details. The consumer is completely and entirely at the mercy of his telephone service company in terms of accessing account details (e.g., to change contact telephone information), learning about telephone service usage, and controlling and managing account changes such as those associated with enhanced calling services (e.g., call waiting, caller ID, voicemail, call forwarding, etc.).

Another example of modern inefficiency is seen with regard to cellular or wireless communications. Typically, a consumer has to visit a wireless communications store, purchase a telephone set, pick from a menu of features and pricing plans, submit an order for service, and then wait for activation prior to placing his first wireless telephone call. And, then, like the residential telephone service customer, the wireless consumer must wait for periodically supplied paper based billing statements to learn about account usage and the like. Wireless consumers (also referred to as subscribers) do not currently have available systems and processes that facilitate self directing or managing their wireless accounts and account usage. It is not uncommon for a wireless subscriber to be surprised by account details that show up sometimes a month later.

Yet another example of modern inefficiencies is seen in the commercial world where business consumers of telecommunications services lack any form of system or process that will enable self direction and management of services, control of costs, and a consumer to seek competitive pricing and services on an ad-hoc basis. Currently, business consumers, like the residential and wireless subscribers mentioned above, often must engage in inefficient live operator based sessions to obtain services, to learn about account details, and to order and facilitate new services.

Service providers have long recognized the foregoing problems associated with provisioning and managing telecommunications services, but have done little to address the same to bring greater efficiencies to market. Instead, service providers have focused their efforts on bringing new and enhanced telecommunications services to market, only to exacerbate the problems realized by consumers in terms of self management of efficiently provided services. For example, MCI (prior to merging with WORLDCOM) attempted to address problems associated with consumers having to sort through numerous paper billing statements to derive an accurate picture associated with telecommunications account usage across a variety of accounts for possibly a variety of services including voice services, paging services, and wireless services. In the MCI solution known as MCI-ONE (a trademark of MCI WORLDCOM, INC.), consumers receive a periodic (monthly) paper based, consolidated billing statement that lists by account, account usage details, etc. like any ordinary billing statement. Unfortunately, the MCI-ONE consolidated statement works only if all services are provided by one vendor such as MCI WORLDCOM, INC. and if the consumer is accepting of a periodic (monthly) paper based bill. MCI-ONE does not offer the consumer the ability to use modern technologies and practices to receive account details across services provided by more than one vendor, and the MCI-ONE statement has nothing to do with account detail setup such as service initiation which remains the province of live operator sessions, etc.

And, in addition to the foregoing problems and resulting inefficiencies associated with existing paper based processes, other problems are soon to be realized by telecommunications providers. For example, as consumers (business and residential alike) are becoming more online enabled, they are also expecting to use newer alternative systems and processes to facilitate acquisition of telecommunications services and management of the same. In particular, consumers will soon expect to use online processes like or similar to online auctioning processes, name your price processes, etc. to acquire telecommunications services. Current paper based solutions like or similar to those discussed above, do not attempt to address such modern needs, thus leaving consumers without the ability to utilize new systems and processes to which they are quickly becoming accustomed.

Thus, there exists a need to provide new and improved systems and methods which permit telecommunications consumers to obtain and manage their services based on their needs and without incorporating outdated business practices and inefficiencies. To be viable, such new and improved systems and methods must take advantage of modern technologies such as networking technologies and processes to permit consumers to self direct and manage their telecommunications services. And, such new and improved systems and methods must facilitate provisioning and managing telecommunications services in converging telecommunications networks via the Internet and World Wide Web (WWW) (and other similar or like networks) based on online auctioning processes and systems.

The present invention squarely addresses the aforementioned problems and delivers such new and improved systems and methods which are described in detail below.

### SUMMARY OF THE INVENTION

The present invention solves the aforementioned problems and provides new and improved systems and methods for integrating network resources within converging telecommunications networks to provision communications services and to consolidate billing data generated by disparate telecommunications devices. Such systems and methods are capable of enabling providers of services to link with other providers seamlessly to provide enhanced services over voice and data networks especially over publicly accessible networks such as the Internet. Consumers of telecommunications services will benefit from the present invention by obtaining greater control over their communications needs and, in particular, will gain the ability to self direct and self-provision the services they need, and the ability to receive consolidated billing notices and the like.

The present invention is based on several fundamental notions. In particular, all communication services eventually will be e-services. That is, all services will be bought, sold, managed and transacted over the Internet through a variety of protocols, transmission mediums, PDA's, wireless devices, backbone devices and vendors. Any company wishing to compete in this new world of communications must be prepared to operate over the Internet. Simply reducing the price on a paper invoice and mailing it won't satisfy customers embracing the Internet and demanding a world run in real-time.

Service providers will gain market share by offering personalized services. Self-provisioning and self-management gives customers the ability to customize their services. Providers now distinguish themselves from competition by delivering a better user experience. Value is now defined more in terms of customer control, convenience and ease-of-use, rather than strictly on price.

The closed, single-vendor proprietary networks are not the future. Multi-vendor, multi-protocol open networks will dominate the new world of communications. To accomplish this, software systems will be the core of network intelligence. Networks will need to support SS7, IN, IP, ATM, H.323, MGCP, Parlay, SIP and a host of protocols that have yet to be invented. Functionality must include multimedia call agents, protocol conversion, gatekeepers, applications, billing, costing, customer management, provisioning, e-commerce, fraud control, authentication, security and network management.

For next-generation systems to be viable the browser can be the only interface. The concept of location is where the Internet connection resides. Customers will demand that their Internet connection follows them rather than installed statically on a desktop PC. All systems must control, manage and deliver applications and content over the existing publicly switched telephone network “PSTN” infrastructure as well as all new world multimedia devices, protocols and languages as they are developed. Of course, everything must be integrated and seamless to the provider and the customer.

Every company that has tried it knows what a difficult task a multi-vendor integration effort is. Huge integration projects will cripple the companies attempting such a strategy in a market that moves in Internet-time. Opportunity cost alone is a reason to look for a more efficient model. The Internet model provides two key operational benefits—all network elements are managed from a single browser and back office, and customer care functions can be managed by the end-user on their own schedule.

By unifying the gamut of technologies available along with Internet-based front and back office applications and transaction-based billing, the present invention makes a new range of services and selling opportunities possible.

Existing proprietary technology and new technologies can for the first time, easily coexist which preserves existing investments, fully utilizes powerful existing technologies and leaves the door open for future technologies that become available.

The present invention supports carrier class TDM technologies by Nortel, Lucent, Ericsson, Siemens, Nokia, Alcatel and Cisco and a host of others. Through MGCP and H.323, the present invention supports all IP-based products. In the context of the present invention, SS7 is fully supported.

Scalability and standards compliance are only two of the hurdles to success in what is now a new, converging telecommunications market. Transactional billing and taxation are next economic impacts of the Internet which most vendors are unprepared to handle. As such, ISPs and backbone providers will soon want to be reimbursed on a usage basis for their services. As with anything successful as an economic force, taxation is soon to follow as worldwide issues surrounding revenue generation on the Internet continue to build momentum. Transactional billing as now provided and supported by the present invention opens the door to a host of new products and services offered on-demand and in real-time.

As such, in solving the aforementioned problems associated with prior systems and processes, and in achieving the above-stated benefits, the present invention provides new systems and methods for facilitating an online auction system that enables acquisition of telecommunications services. The system includes an online auction facility operable to facilitate an online auction and to permit a telecommunications service to be auctioned to a high bidder. The online auction system also includes a service provider system that is coupled to the online auction facility via an electronic data network. The service provider system is operable to automatically provide the telecommunications service to the high bidder automatically when the high bidder wins the online auction.

### BRIEF DESCRIPTION OF THE DRAWING FIGURES

The present invention is described in detail below with reference to the attached drawing figures, of which:

FIG. 1 is a diagram of a system in which telecommunications services may be provisioned and billed based on customer specifications received in real time and on-demand and as a result of auction processes in accordance with a preferred embodiment of the present invention;

FIG. 2 is a block diagram of a data processing system that may be used to implement control systems, interfacing facilities, and database management facilities in accordance with a preferred embodiment of the present invention; and

FIG. 3 is a flowchart that illustrates operations that are carried out within the system shown in FIG. 1 to facilitate an online auction for telecommunications services in accordance with a preferred embodiment of the present invention.

### DETAILED DESCRIPTION OF THE PREFERRED EMBODIMENTS

The present invention is now discussed in detail with regard to the attached drawing figures which were briefly described above. Unless otherwise indicated, like parts and processes are referred to with like reference numerals.

### Structural Aspects of the Present Invention

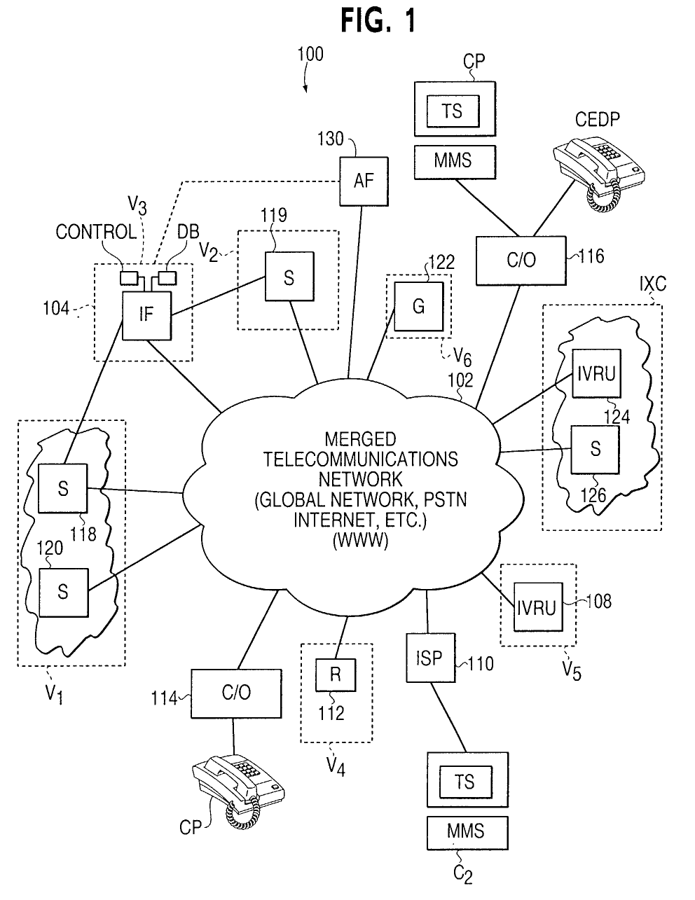

Referring now to FIG. 1, depicted therein is a diagram of a system in which customers may access a merged telecommunication network to receive merged telecommunications services based the operations of an automatic auction system and process in accordance with a preferred embodiment of the present invention. Such merged services may include provisioned services from possibly a multitude of vendors, consolidated billing statements, etc. all in real time and via a web enabled interface such as one that permits access via the Internet and World Wide Web. In particular, system 100 includes a merged telecommunications network which may include at least portions of a global network, the publicly switched telephone network (PSTN), the Internet and WWW, etc. Moreover, system 100 may include vendor communications systems V1 through V6 (among others), wherein each vendor system may include switching systems, interactive voice response units, control facilities and database management facilities, interfacing facilities and a host of other telecommunications devices found in modern telecommunications networks and which may be accessed in merged telecommunications network 102 using a variety of modern communications protocols and device messaging schemes.

In system 100, a calling party such as calling party CP (who may also be a WWW user) may utilize calling services through a central office 114 which is coupled to merged telecommunications network 102 to receive telecommunication services based upon communications functions provided by telecommunications devices such as those provided by vendors V1-V6. For example, a particular telecommunications service may include the operations of a router such as router 112 in the context of data based telecommunications services, voice response services, such as those provided by vendor V5 via IVRU unit 108, gateway services provided by gateway system 122 which is provided by vendor V6, etc. Moreover, telecommunications services may include voice calls which ultimately terminate at a called party such as CEDP party via central office 116. Furthermore, customer systems C1 and C2 may incorporate multimedia telecommunications systems including computing platforms that facilitate multimedia communications via merged telecommunications network 102. Such services may be provided via vendor systems V1 and V3 along with an Inter-Exchange Carrier system denoted by system IXC (denoted by phantom lines forming a box around a vendor network that includes interactive voice response unit (IVRU) 124 and a switching platform 126).

Within system 100, vendor V3, for example, is shown to include control facilities, database management facilities DB and an interfacing facility IF. The control facilities in conjunction with the database management facilities DB and the interfacing facility IF, permit customers to custom configure (self-direct) telecommunications services on demand and in real time (e.g., during normal business operations) via couplings made automatically within the merged telecommunications network 102. For example, interfacing facility IF of vendor system V3 may incorporate switching facilities 118, 119, and 120 along with IVRU facilities 108 to provide a custom configured telecommunications service in real time. That is, each communications function provided by a particular telecommunications device or facility within system 100 may be treated as an inventory item within merged telecommunications network 102, for example, to facilitate custom configuration of telecommunications services on demand and based on customer requirements. Accordingly, a customer such as customer C2 may access merged telecommunications network 102 and ultimately, interfacing facility IF of vendor system V3 to custom configure bandwidth allocation services on demand and in real time without the need to request such services in advance and via live operator intervention. Accordingly, customer C2 may access an ISP system 110 to provide access to merged telecommunications network 102, for example, to engage the operations of interfacing facility IF of vendor system V3 in the abstract so that in the event that communications functions provided by disparate telecommunications devices are needed to fulfill a particular customer request, it then can be provisioned in the abstract without requiring the customer to specifically understand or be able to message to possibly disparate telecommunications devices. Furthermore, a customer requiring merged voice and data type communications services now may access a merged telecommunication network in consideration of the present invention to ultimately access IXC services, such as voice response and switching services provided IVRU facilities 124 and switching facilities 126 in combination with other services provided within merged telecommunications network 102 to provision enhanced telecommunications services on demand and in real time based upon specific customer specifications.

Furthermore, the interfacing facilities IF provided by vendor V3, for example, permit telecommunications devices and facilities within merged telecommunications network 102 to transmit billing and accounting data related to the provision telecommunications services to a central or otherwise consolidated data facility such as data facility 104 which includes interfacing facility IF, control facilities and database management facilities DB, and to ultimately, provide such consolidated billing data to a customer for appropriate processing thereby. For example, in the event that extended or extra bandwidth is a telecommunications service to be provided within merged telecommunications network 102 at the request of a customer in real time, such extended bandwidth may require certain switching facilities, such as switching facility 118, and switching facility 119, to be including in the provision of that particular bandwidth telecommunications service. Accordingly, the present invention now permits switching system 118 and switching facility 119, for example, to transmit billing data to a consolidated billing facility whereby billing data, possibly incorporating billing data generated by disparate telecommunications devices (e.g., devices communicating and messaging in accordance with disparate telecommunications protocols, etc.), communicating in accordance with disparate protocols and messaging schemes, to be consolidated and ultimately reported within a single or consolidated notice or message provided via merged telecommunication network 102.

In system 100, auction facilities (AF) 130 are online accessible auctioning facilities that permit users to engage in bid-offer type operations related to goods and services that may be put up for auction. In the context of the present invention, such services may be pre-built such as bandwidth services or long distance service, or customer-built/driven services to be built and provisioned based on customer specifications. In other words, a user/consumer of telecommunications services may self-specify a service (e.g., a bandwidth service, a voicemail service, a global video conference, etc.) which others may (or may not) be interested in and thereby place an opening bid or a series of bids in relation to acquisition and provisioning of that service. In this way, a particular service which may otherwise not be available may now be provisioned by one or more service providers as perceived demand will justify the provisioning of the service. In any case, the present invention now permits well known auctioning systems and processes such as those commonly used by online auction houses (e.g., www.ebay.com, yahoo auctions, etc.) to be used to facilitate online acquisition of telecommunications services which later may be provisioned to one or more consumers. Software systems including those manufactured by AUCTION BROKER, INC. (e.g., AUCTION BROKER Software V.4.4—www.auctionbroker.com) may be used to implement the features of an online auction facility that may be utilized in the context of the present invention to permit users to participate in online auctions to facilitate acquisition of telecommunications services on demand and, possibly, in real time.

It should also be noted that auction facilities AF 130 may be run as a software system within interface facility IF and need not necessarily be separated as shown in system 100. Alternatively, auction facilities AF 130 may be directly coupled to other structures such as interface facility 104 to facilitate rapid, dedicated communications and messaging to facilitate acquisition of telecommunications services in accordance with the present invention.

After an auction process is terminated such as by automatic termination by auction facilities AF 130 at a particular pre-determined time, etc., notification of auction results may be sent to a customer (e.g., a WWW user, etc.) and to one or more service providers within system 100 who offered or are otherwise situated to deliver the auctioned telecommunications services. Accordingly, after an auction process has terminated, auctioned telecommunications services may now be automatically provisioned such as via communications with interface facility IF without requiring human interaction, paper-based systems and processes, etc. And, any user parameters (terminating telephone number, network addresses, etc.) affecting delivery of auctioned services may be entered prior to or at the time auction bidding, after auction termination automatically, etc. For example, in the case of pre-constructed telecommunications services, such as long distance service, most of the service parameters may be specified before bidding, except for connection numbers and the like which can't be specified until a bid winner is selected. Alternatively, custom-built services may require that most or all of the parameters needed to provide the service be specified after the selection of bid winners.

The operations of interface facility IF within vendor system V3, for example, are illustrated and described in detail in co-owned, co-pending U.S. patent application Ser. Nos. 09/414,668 09/514,208 both entitled “SYSTEM AND METHOD FOR COMMUNICATING WITH AND CONTROLLING DISPARATE TELECOMMUNICATIONS DEVICES IN A TELECOMMUNICATIONS NETWORK,” filed on Oct. 7, 1999, and Feb. 28, 2000, respectively, which are incorporated herein by reference. Accordingly, the reader of this patent document should refer to the aforementioned co-owned, co-pending U.S. patent applications for complete disclosure details related to the operations of interfacing facility IF in the context of provisioning and providing provisioning operations based on common interfacing and message along with consolidated billing operations in accordance with the present invention.

Furthermore, the operations to provision multiple device functions to deliver telecommunications services and to manage billing practices related to the same such as those which may be provisioned and billed (accounted for) in response to web based requests from customers, are detailed in co-owned, co-pending U.S. patent application Ser. Nos. 09/______, and 09/______ entitled “SYSTEM AND METHOD FOR PROVIDING COMMUNICATION SERVICES ON DEMAND BY PROVISIONING DEVICES IN CONVERGING TELECOMMUNICATIONS NETWORKS (0004)” and “SYSTEM AND METHOD FOR BILLING COMMUNICATIONS SERVICES PROVISIONED ON DEMAND IN CONVERGING TELECOMMUNICATIONS NETWORKS (0005),” both filed on Feb. 28, 2000, which are hereby incorporated by reference. Accordingly, the reader of this patent document should refer to the aforementioned co-owned, co-pending U.S. patent applications for detailed disclosure related to this patent document.

The aforementioned and incorporated patent application documents and disclosures are hereby made part of this specification.

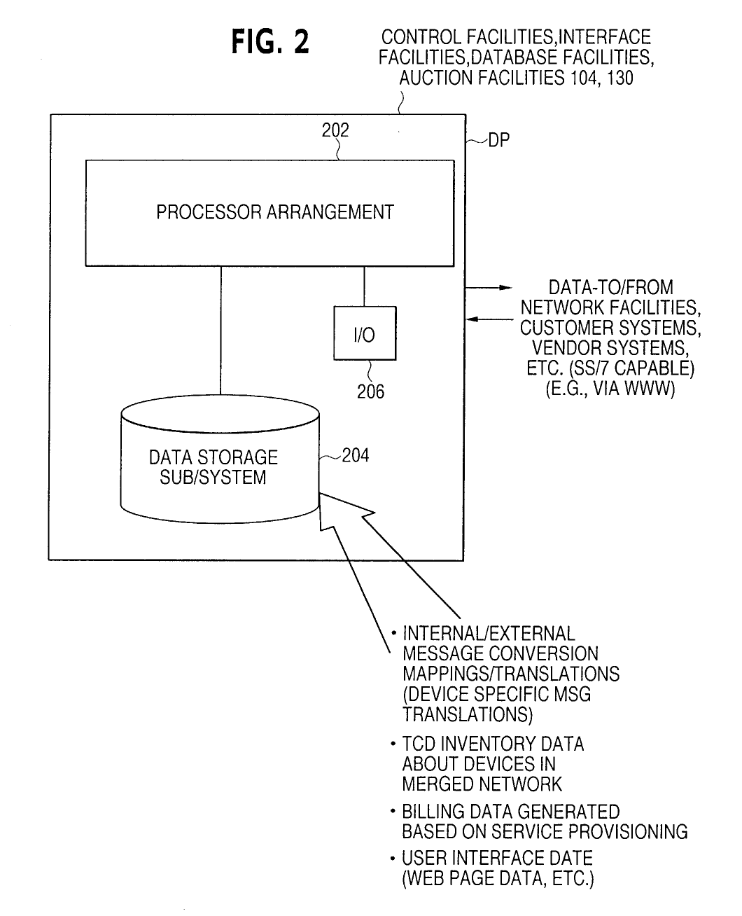

Referring now to FIG. 2, depicted therein is a block diagram of a computing system which may be used to implement control facilities, auction facilities AF 130, interfacing facilities and database management facilities as described above with regard to FIG. 1 in accordance with a preferred embodiment of the present invention. In particular, FIG. 2 depicts a data processing system DP that further includes a processor arrangement 202 including one or more processing elements, a data storage subsystem 204, and an 10 facility 206. The arrangement of these structures shown with data processing system DP will be immediately understood by those skilled in the art.

Data processing system DP is configured to receive and transmit data to and from network facilities, customer systems, vendor systems, auction facilities AF 130, etc. via modern telecommunications protocols including, but not limited to, those used in SS7 out-of-band signaling systems, TCP/IP protocols, H.323 communications protocols, and any other telecommunications protocols which may used to facilitate messaging between telecommunications devices in accordance with the present invention.

Data storage subsystem 204 as shown within data processing system DP, may include internal and external messaging conversion mappings and translations, which may be used to convert device specific messages (external messages) generated by specific telecommunications devices within merged telecommunications network 102 (FIG. 1) into internal messages (IMs) which are device independent which may be used to consolidate application type data to including billing operation data etc. Data storage subsystem 204 may store and provide telecommunications device (TCD) inventory data about particular telecommunication devices in merged telecommunications network 102. And, data storage subsystem 204 may include billing data generated based on service provisioning and, in particular, billing data generated by particular telecommunications devices within merged telecommunications network 102.

The structures described above with regard to FIGS. 1 and 2 are web enabled via open standards technology to support web based transactions and operations. Such operations need not involve traditional paper-based transactions and processes. The aforementioned and incorporated patent applications describe structure, processes, and methods, which may be used to facilitate such web, enabled functionality.

As such, the present invention permits all communication services to be e-services. That is, all services may now be bought, sold, managed and transacted over the Internet through a variety of protocols, transmission mediums, PDA's, wireless devices, backbone devices and vendors. Any company wishing to compete in this new world of communications must be prepared to operate over the Internet. Simply reducing the price on a paper invoice and mailing it won't satisfy customers embracing the Internet and demanding a world run in real-time.

Accordingly, service providers can now gain market share by offering personalized services. Self-provisioning and self-management gives customers the ability to customize their services. Providers can now distinguish themselves from competition by delivering a better user experience. Value is now defined more in terms of customer control, convenience and ease-of-use, rather than strictly on price.

The closed, single-vendor proprietary networks are not the future. Multi-vendor, multi-protocol open networks will dominate the new world of communications. To accomplish this, software systems are the core of network intelligence. Networks will need to support SS7, IN, IP, ATM, H.323, MGCP, Parlay, SIP and a host of protocols that have yet to be invented. Functionality must include multimedia call agents, protocol conversion, gatekeepers, applications, billing, costing, customer management, provisioning, e-commerce, fraud control, authentication, security and network management.

For next-generation systems to be viable the browser can be the only interface. The concept of location is where the Internet connection resides. Customers will demand that their Internet connection follows them rather than installed statically on a desktop PC. All systems must control, manage and deliver applications and content over the existing publicly switched telephone network “PSTN” infrastructure as well as all new world multimedia devices, protocols and languages as they are developed. Of course, everything must be integrated and seamless to the provider and the customer.

Every company that has tried it knows what a difficult task a multi-vendor integration effort is. Huge integration projects will cripple the companies attempting such a strategy in a market that moves in Internet-time. Opportunity cost alone is a reason to look for a more efficient model. The Internet model provides two key operational benefits—all network elements are managed from a single browser and back office, and customer care functions can be managed by the end-user on their own schedule.

By unifying the gamut of technologies available along with Internet-based front and back office applications and transaction-based billing, the present invention makes a new range of services and selling opportunities possible.

Existing proprietary technology and new technologies can for the first time, easily coexist which preserves existing investments, fully utilizes powerful existing technologies and leaves the door open for future technologies that become available.

The present invention supports carrier class TDM technologies by Nortel, Lucent, Ericsson, Siemens, Nokia, Alcatel and Cisco and a host of others. Through MGCP and H.323, the present invention supports all IP-based products. In the context of the present invention, SS7 is fully supported.

When the system shown in FIG. 2 is implemented to process auctions such as in the case of auction facilities AF 130, the same may be implemented as a computing platform that is outfitted with auction software and processes such as those made possible using AUCTION BROKER SOFTWARE V.4.4 which is manufactured and marketed by AUCTION BROKER, INCORPORATED.

### Operational Aspects of the Present Invention

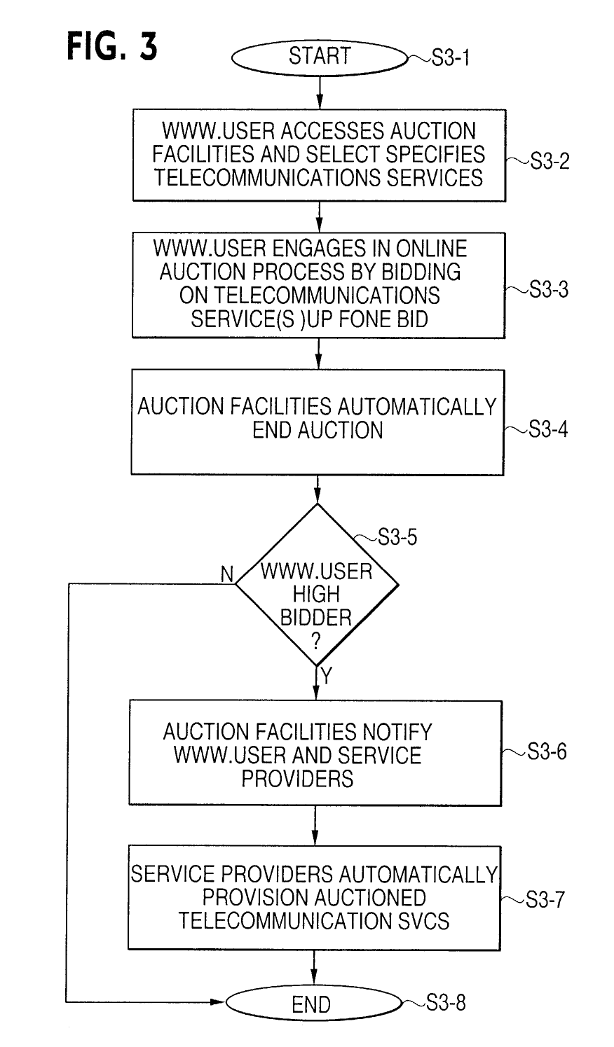

The structures described and referenced above are designed, configured, and arranged to support an online auction facility that may be accessed by WWW users to facilitate provisioning of telecommunications services auctioned online. The operations to carry out and provide such functionality are illustrated in FIG. 3 to which reference is now made.

In particular, processing and operations start at step S3-1 and immediately proceed to step S3-2.

At step S3-2, a WWW user accesses auction facilities such as via a web traversal (via a URL, etc.) to select/specify telecommunications up for bid.

Next, at step S3-3, the WWW user engages in an online type auction process by bidding on the selected/specified telecommunications services.

Next, at step S3-4, auction facilities such as those provided by auction facilities AF 130 (FIG. 1) automatically end the auction such as at a particular pre-specified time.

Next, at step S3-5, a determination will be made as to whether the WWW user is the high bidder (or a bid winner). If not, processing and operations end at step S3-8.

If the WWW user is the high bidder (or a bid winner) in the auction, processing and operations continue at step S3-6. At step S3-6, auction facilities AF 130, for example, will notify the WWW user and the service providers responsible for providing the selected/specified telecommunications services. As already described above with reference to system 100, the telecommunications service parameters can be specified before, during or after the auction process, and therefore, appropriate action could be taken to provide the parameters of the particular telecommunications service to the service provider.

Next, at step S3-7, the responsible service provider(s) will automatically provision or otherwise act in regard to the auctioned telecommunications services.

Processing and operations, as noted above, end at step S3-8.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

What is claimed is:

1. A system for provisioning of telecommunications services within a telecommunications environment based on results of an online auction, comprising:
a telecommunications service provider system configured to be controlled to provide at least one telecommunications service to a customer;
an auction facility configured to automatically permit said customer to engage in an online auction process to acquire said at least one telecommunications service; and
a server system coupled to said telecommunications service provider system and said auction facility via an electronic data network, said server system, based on said online auction process, storing and serving at least one user interface form corresponding to said at least one telecommunications service, said server system configured to be accessed by said customer via said electronic data network to enable the customer to receive and process said at least one user interface form and, in response to user specifications transmitted to said server system based on said at least one user interface form, to facilitate automatic control of said telecommunications service provider system to provision said at least one telecommunications service to the customer.

2. The system according to claim 1, wherein said telecommunications service provider system is a telecommunications service network in which said at least one telecommunications service is a voicemail service.

3. The system according to claim 1, wherein said server system is a web server system accessible via the Internet.

4. The system according to claim 1, wherein said at least one user interface form is an HTML form configured to be processed within a browser application running within a client data processing system coupled to said server system via the Internet.

5. The system according to claim 1, wherein said user specifications are specified by the customer based on content found within said at least one user interface form.

6. The system according to claim 5, wherein said user specifications are pricing requirements established by the customer to correspond to said at least one telecommunications service provisioned by said telecommunications service provider system.

7. The system according to claim 1, wherein said at least one telecommunications service is a cellular telephony service.

8. The system according to claim 1, wherein said at least one telecommunications service is a pre-paid telephony service including pre-paid voice-based telephone calling services.

9. The system according to claim 1, wherein said at least one telecommunications service is a pre-paid telephony service including pre-paid data calling services.

10. The system according to claim 1, further comprising bidding means for permitting the customer to bid at least one price to correspond to at least one telecommunications service to be provisioned by said telecommunications service provider system if a selling entity accepts said at least one price.

11. The system according to claim 1, wherein said telecommunications service provider system includes a plurality of telecommunications devices each of which configured to provide a telecommunications function which may be combined with other telecommunications functions to provision said at least one telecommunications service.

12. A method for provisioning telecommunications services within a telecommunications environment, comprising the steps of:
at a server system, storing and serving at least one user interface form corresponding to at least one telecommunications service;
operating an online auction facility configured to hold at least one auction corresponding to said at least one telecommunications service;
in response to said at least one auction, permitting access to said server system to a customer to enable the customer to receive and process said at least one user interface form within a browser application; and
in response to user specifications transmitted to said server system based on said at least one user interface form, facilitating automatic control of a telecommunications service provider system to provision said at least one telecommunications service to the customer.

13. The method according to claim 12, wherein said telecommunications service provider system is a telecommunications service network in which said at least one telecommunications service is a voicemail service.

14. The method according to claim 12, wherein said server system is a web server system accessible via the Internet.

15. The method according to claim 12, wherein said at least one user interface form is an HTML form configured to be processed within said browser application running within a client data processing system coupled to said server system via the Internet.

16. The method according to claim 12, wherein said user specifications are specified by the customer based on content found within said at least one user interface form.

17. The method according to claim 15, wherein said user specifications are pricing requirements established by the customer to correspond to said at least one telecommunications service provisioned by said telecommunications service provider system.

18. The method according to claim 12, wherein said at least one telecommunications service is a cellular telephony service.

19. The method according to claim 12, wherein said at least one telecommunications service is a pre-paid telephony service including pre-paid voice-based telephone calling services.

20. The method according to claim 12, wherein said at least one telecommunications service is a pre-paid telephony service including pre-paid data calling services.

21. The method according to claim 12, further comprising bidding means for permitting the customer to bid at least one price to correspond to at least one telecommunications service to be provisioned by said telecommunications service provider system if a selling entity accepts said at least one price.

22. The method according to claim 12, wherein said telecommunications service provider system includes a plurality of telecommunications devices each of which configured to provide a telecommunications function which may be combined with other telecommunications functions to provision said at least one telecommunications service.

23. An online auction system for facilitating acquisition of telecommunications services, comprising:
an online auction facility operable to facilitate an online auction and permitting a telecommunications service to be auctioned to a high bidder; and
a service provider system coupled to said online auction facility via an electronic data network, said service provider system operable to automatically provide said telecommunications service to said high bidder automatically when said high bidder wins said online auction.
